(19) United States
(12) Patent Application Publication
(10) Pub. No.: US 2025/0342620 A1
(43) Pub. Date: Nov. 6, 2025

(54) DIFFERENTIABLE COMPOSITION OF ATTRIBUTES IN STYLE TRANSFER

(71) Applicant: DISNEY ENTERPRISES, INC., Burbank, CA (US)

(72) Inventors: Raphael Francois ORTIZ, Zurich (CH); Abdelaziz Djelouah, Zurich (CH); Christopher Richard Schroers, Uster (CH)

(21) Appl. No.: 18/655,147

(22) Filed: May 3, 2024

(51) Int. Cl. G06T 11/00

(52) U.S. Cl. CPC G06T 11/001; G06T 2207/20084

(57) ABSTRACT

One embodiment of the present invention sets forth a technique for performing style transfer. The technique includes determining a first set of attribute values for a plurality of attributes associated with a content sample. The technique also includes computing one or more losses based on the content sample and one or more style samples and converting, based on the one or more losses, the first set of attribute values into a second set of attribute values for the plurality of attributes. The technique further includes generating a style transfer result based on a composite of the second set of attribute values.

### BACKGROUND

### Field of the Various Embodiments

Embodiments of the present disclosure relate generally to machine learning and computer vision and, more specifically, to techniques for differentiable composition of attributes in style transfer.

### DESCRIPTION OF THE RELATED ART

Style transfer refers to a technique for transferring the “style” of a first image onto a second image without modifying the content of the second image. For example, colors, patterns, and/or other style-based attributes of the first image may be transferred onto one or more faces, buildings, bridges, and/or other objects in the second image without removing the objects from the second image or adding new objects to the second image.

Neural style transfer (NST) refers to a category of style transfer techniques that leverage convolutional neural networks (CNNs) to perform style transfer. NST techniques typically extract features from both the content and style images using a pre-trained CNN and modify the features of the content image to match those of the style image. The modified features are then used to generate a new image that has the content of the original image and the style of the style image. For example, an encoder neural network could be used to generate feature maps for both the content and style images. A mean and standard deviation may be calculated for one or more portions of the feature map for the style image, and the corresponding portion(s) of the feature map for the content image may be normalized to have the same mean and standard deviation. A decoder network could then be used to convert the normalized feature map into an output image that combines the style of the style image with the content of the content image.

Within the category of NST, Neural Neighbor Style Transfer (NNST) has emerged as a technique for performing high-quality generalizable style transfer. The NNST technique extracts features from both the content and style images and replaces the features of the content image with the nearest match in the pool of style features. The image that would have produced such a feature map is then found through a feedforward and/or optimization process.

However, the NNST approach is associated with a number of drawbacks. First, all features from the style image have to be stored in memory to perform the nearest neighbor search, which becomes infeasible at higher resolutions. These memory-based limits also restrict both the number of style images that can be used in the style transfer process and the ability to perform data augmentation (e.g., extracting features on scaled, rotated, and/or other variants of a given style image), which can negatively impact the quality of the style transfer output. Second, the latency of the nearest neighbor search increases with the number of features. These drawbacks interfere with the use of style transfer in productions of movies and/or other applications that involve high image resolutions, faster speeds, and/or a wide range of styles.

As the foregoing illustrates, what is needed in the art are more effective techniques for performing style transfer.

### SUMMARY

One embodiment of the present invention sets forth a technique for performing style transfer. The technique includes determining a first set of attribute values for a plurality of attributes associated with a content sample. The technique also includes computing one or more losses based on the content sample and one or more style samples and converting, based on the one or more losses, the first set of attribute values into a second set of attribute values for the plurality of attributes. The technique further includes generating a style transfer result based on a composite of the second set of attribute values.

One technical advantage of the disclosed techniques relative to the prior art is the ability to generate high-resolution style transfer results in a computationally feasible manner. Accordingly, the disclosed techniques improve the quality of style transfer results and resource overhead over conventional approaches that involve storing features from style samples in memory. Another technical advantage of the disclosed techniques is an increase in the customizability and level of control in the style transfer process through the use of layers, parameterizations, levels of stylization, control maps, and/or style variants to adjust specific attributes of a content sample to match those of one or more style samples. These technical advantages provide one or more technological improvements over prior art approaches.

### BRIEF DESCRIPTION OF THE DRAWINGS

The patent application or application file contains at least one drawing executed in color. Copies of this patent or patent application publication with color drawings will be provided by the Office upon request and payment of the necessary fee.

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the training engine and execution engine of FIG. 1, according to various embodiments.

FIG. 3A shows an example style sample, content sample, and style transfer result, according to various embodiments.

FIG. 3B shows an example style sample, content sample, set of attributes associated with the content sample, and style transfer result, according to various embodiments.

FIG. 3C shows an example style sample, content sample, set of attributes associated with the content sample, and style transfer result, according to various embodiments.

FIG. 3D shows an example style sample, content sample, set of attributes associated with the content sample, and style transfer result, according to various embodiments.

FIG. 4 is a flow diagram of method steps for performing style transfer using a variational autoencoder (VAE), according to various embodiments.

FIG. 5 is a flow diagram of method steps for parametrization-based optimization of attributes during style transfer, according to various embodiments.

FIG. 6 is a more detailed illustration of the training engine and execution engine of FIG. 1, according to various embodiments.

FIG. 7 is a flow diagram of method steps for performing semi-supervised style transfer, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

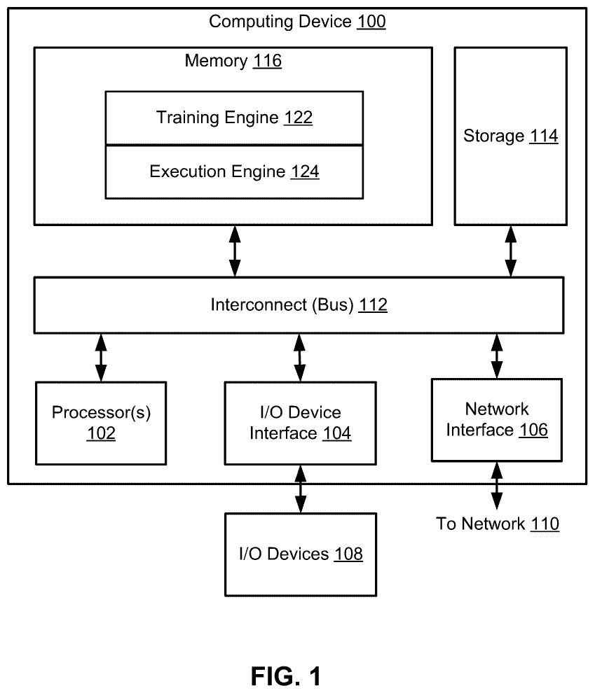

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in memory 116.

It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100. In another example, training engine 122 and/or execution engine 124 could execute on various sets of hardware, types of devices, or environments to adapt training engine 122 and/or execution engine 124 to different use cases or applications. In a third example, training engine 122 and execution engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In some embodiments, training engine 122 and execution engine 124 use one or more machine learning models and/or optimization techniques to perform a style transfer task, in which the style of one or more style samples (e.g., one or more images in a corresponding style) is combined with the content of a content sample (e.g., one or more images in a style that differs from that of the style sample) into a style transfer result. Training engine 122 trains one or more machine learning models to learn features that can be used in the style transfer task. These machine learning models include one or more variational autoencoders (VAEs) that learn to convert a set of features extracted from the style sample(s) into one or more embeddings in a lower-dimensional latent embedding space, and to reconstruct the set of features from the embedding(s). The machine learning models also, or instead, include an image-to-image translation model (e.g., a feedforward neural network) that is trained to learn a mapping between the content associated with a sequence of video frames and a relatively small set of ground truth “stylized” frames that are paired with certain key frames within the sequence of content video frames.

Execution engine 124 uses the trained machine learning models and/or other techniques to optimize for different aspects of the style transfer task. More specifically, execution engine 124 can use the trained VAE to project a first set of features representing a content sample into a second set of features in the feature space of the style sample(s). Execution engine 124 can then optimize and/or adjust various attributes of the content sample until the features for the content sample match those of the style sample(s) and/or until one or more losses between the first and second set of features have been reduced. Execution engine 124 can also, or instead, use the image-to-image translation model to apply the style associated with a set of “stylized” key frames to a sequence of video frames that include non-stylized versions of the key frames and additional video frames that lack stylized counterparts. The operation of training engine 122 and execution engine 124 is described in further detail below.

### Improving Speed and Flexibility in Style Transfer

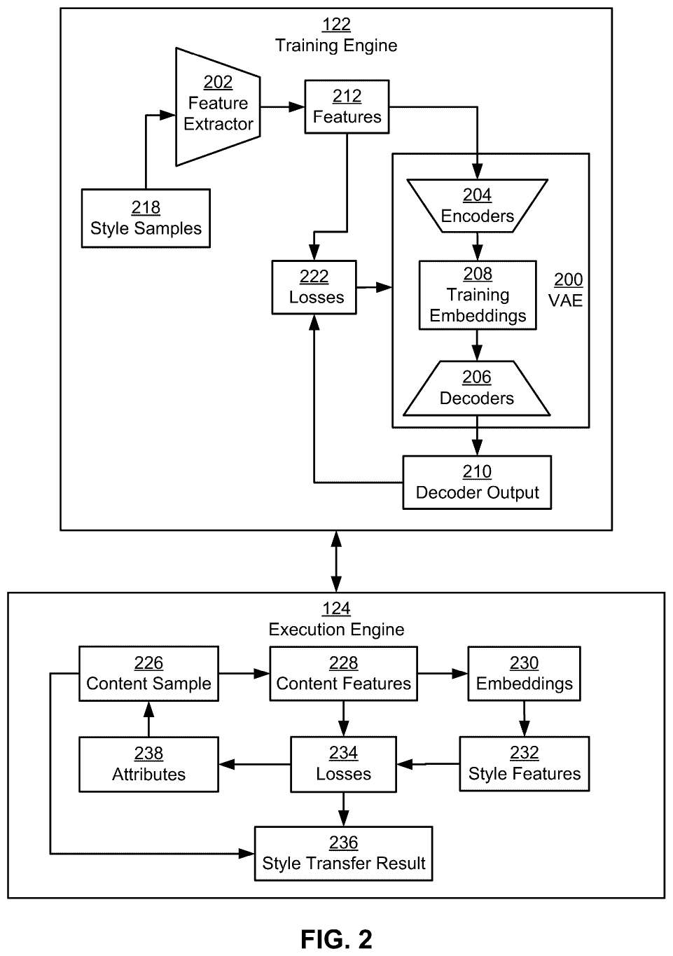

FIG. 2 is a more detailed illustration of training engine 122 and execution engine 124 of FIG. 1, according to various embodiments. As mentioned above, training engine 122 and execution engine 124 operate to train and execute one or more machine learning models during a style transfer task that combines the content of a content sample 226 with the style of one or more style samples 218 into a style transfer result 236.

Content sample 226 includes a visual representation and/or model of one or more content-based attributes. For example, content sample 226 may include one or more images, meshes, sequences of video frames, and/or other two-dimensional (2D) or three-dimensional (3D) depictions of one or more objects (e.g. face, building, vehicle, animal, plant, road, water, landscape, scene, etc.) and/or abstract shapes (e.g., lines, squares, round shapes, curves, polygons, etc.). Content-based attributes of content sample 226 may include distinguishing visual or physical attributes, hierarchies, or arrangements of these objects and/or shapes (e.g., a face is an object that includes a recognizable arrangement of eyes, ears, nose, mouth, hair, and/or other objects, and each object inside the face is represented by a recognizable arrangement of lines, angles, polygons, and/or other abstract shapes).

Style samples 218 include visual and/or other representations of one or more style-based attributes. For example, style samples 218 may include one or more drawings, paintings, sketches, renderings, photographs, video frames, and/or other 2D or 3D depictions that are different from content sample 226. Style-based attributes of style samples 218 may include, but are not limited to, brush strokes, lines, edges, patterns, colors, bokeh, textures, and/or other artistic or naturally occurring attributes that define the manner in which content is depicted.

Training engine 122 trains a variational autoencoder (VAE) 200 to reconstruct a set of features 212 representing style samples 218. As shown in FIG. 2, training engine 122 uses a feature extractor 202 to extract features 212 from style samples 218. For example, as feature extractor 202, training engine 122 could use a pre-trained Visual Geometry Group (VGG), ResNet, Inception, MobileNet, DarkNet, AlexNet, GoogLeNet, and/or another type of deep CNN that is trained to perform image classification, object detection, and/or other tasks related to a dataset of images. Features 212 extracted using this feature extractor 202 could include (but are not limited to) low-level information (e.g., edges, corners, blobs, etc.) from initial layers of feature extractor 202 and/or higher-level semantic information (e.g., types of objects) from intermediate layers of feature extractor 202.

In some embodiments, training engine 122 normalizes features 212 outputted by feature extractor 202. For example, training engine 122 could subtract the mean of each feature channel from the corresponding feature values to generate “centered” versions of features 212.

Training engine 122 also inputs features 212 (e.g., after normalization) into one or more encoders 204 in VAE 200. Each of encoders 204 converts a corresponding set of features 212 into one or more training embeddings 208 in a lower-dimensional latent embedding space. Training engine 122 inputs these training embeddings 208 into one or more decoders 206 in VAE 200. Each of decoders 206 converts a corresponding set of inputted training embeddings 208 into decoder output 210 that represents a reconstruction of features 212 inputted into encoders 204.

In some embodiments, VAE 200 includes a different encoder-decoder pair for each layer of feature extractor 202 used to generate features 212 of style samples 218. For example, VAE 200 could include N encoder-decoder pairs for N layers of feature extractor 202 from which features 212 are obtained. Each encoder in VAE 200 could include a set of fully connected layers that convert a feature vector of a certain length from a corresponding layer of feature extractor 202 into an embedding. Each decoder in VAE 200 could include a different set of fully connected layers that convert one or more embeddings produced by the corresponding encoder into a subset of decoder output 210 that represents a reconstruction of the feature vector inputted into the encoder. The fully connected layers in encoders 204 and decoders 206 of VAE 200 act as pointwise convolutions on the corresponding feature vectors.

Training engine 122 computes one or more losses 222 between features 212 extracted by feature extractor 202 from style samples 218 and decoder output 210. Training engine 122 also updates the parameters of VAE 200 based on losses 222. For example, training engine 122 could compute a reconstruction loss between features 212 and decoder output 210 and/or a Kullback-Leibler (KL) divergence between the learned distribution of training embeddings 208 in the lower-dimensional latent embedding space and a target (e.g., prior) distribution such as a Gaussian. Training engine 122 could also use a training technique (e.g., gradient descent and backpropagation) to iteratively update weights of encoders 204 and/or decoders 206 in a way that reduces the reconstruction and/or KL-based losses 222. These losses 222 allow VAE 200 to learn a smooth and continuous latent embedding space that can be used to reconstruct and/or interpolate between normalized features 212 in the feature space (e.g., manifold) associated with features 212 extracted from style samples 218.

In one or more embodiments, training engine 122 trains VAE 200 using multiple variants of style samples 218. For example, training engine 122 could upscale and/or downscale style samples 218 (e.g., by resampling style samples 218 using a random scale factor drawn from a log-uniform distribution and/or a gamma factor to skew toward small or large scales) to generate multiple versions of style samples 218 at different resolutions and/or levels of detail. Training engine 122 could also, or instead, rotate, flip, crop, translate, and/or otherwise augment style samples 218 to generate additional variants of style samples 218. Training engine 122 could then train VAE 200 using these variants by optimizing for all scales and/or variants of style samples 218 at the same time. Training engine 122 could also, or instead, generate a different scale and/or variant of style samples 218 for use with each training iteration used to train VAE 200.

After training of VAE 200 is complete, execution engine 124 uses the trained VAE 200 and one or more optimization techniques to combine content-based attributes of content sample 226 and style-based attributes of style samples 218 into style transfer result 236. More specifically, execution engine 124 uses feature extractor 202 to extract a set of content features 228 from content sample 226. Execution engine 124 uses one or more encoders 204 in the trained VAE 200 to convert these content features 228 into corresponding embeddings 230 in the learned latent embedding space of VAE 200. Execution engine 124 then uses one or more decoders 206 in the trained VAE 200 to convert embeddings 230 into a set of style features 232 in the feature space associated with style samples 218.

Execution engine 124 computes one or more losses 234 between content features 228 and style features 232. For example, execution engine 124 could compute an L1 loss, L2 loss, perceptual loss, cosine distance, Euclidean distance, and/or another type of loss as a measure of difference and/or distance between content features 228 and style features 232.

Execution engine 124 also iteratively optimizes for one or more attributes 238 of content sample 226 based on losses 234. For example, execution engine 124 could use a coordinate descent technique, gradient descent technique, and/or another type of optimization technique to iteratively update pixel values and/or other attributes 238 of content sample 226 in a way that reduces losses 234 between content features 228 and style features 232. Execution engine 124 could also use the trained VAE 200 to compute a new set of content features 228 using a representation of content sample 226 that incorporates the updated attributes 238. Execution engine 124 could additionally compute a new set of losses 234 between the new set of content features 228 and style features 232 and backpropagate these losses 234 as adjustments to attributes 238 until a certain number of iterations has been performed, losses 234 converge and/or fall below a threshold, and/or other criteria are met.

Once the criteria associated with optimization of attributes 238 based on losses 234 are met, execution engine 124 uses the corresponding optimized content sample 226 as style transfer result 236. This style transfer result 236 includes attributes 238 that reflect low-level information (e.g., edges, corners, blobs, etc.) and/or higher-level semantic information (e.g., types of objects) encoded in style features 232 associated with style samples 218, as well as distinguishing visual or physical attributes of content sample 226.

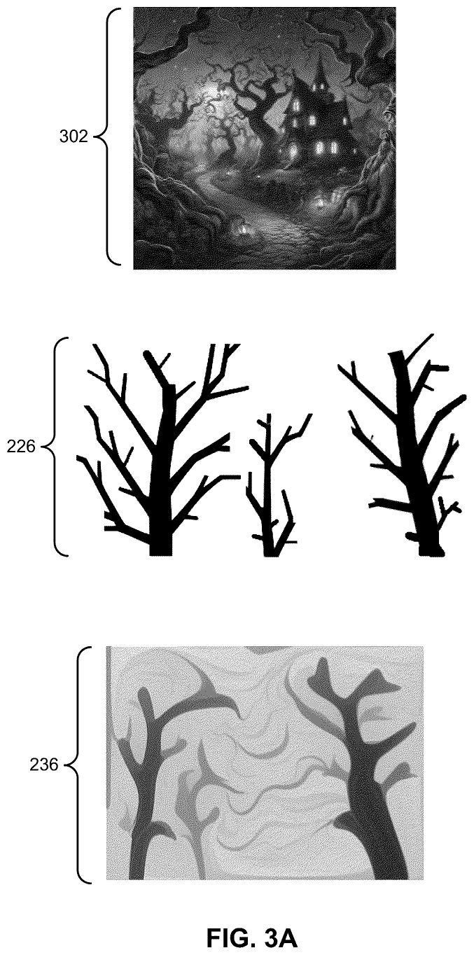

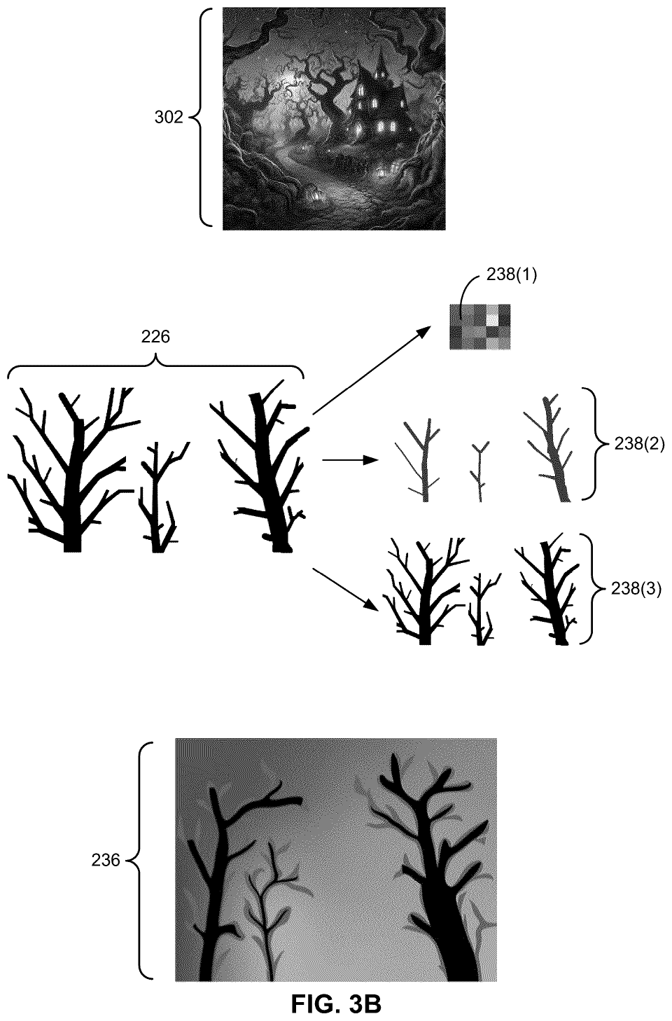

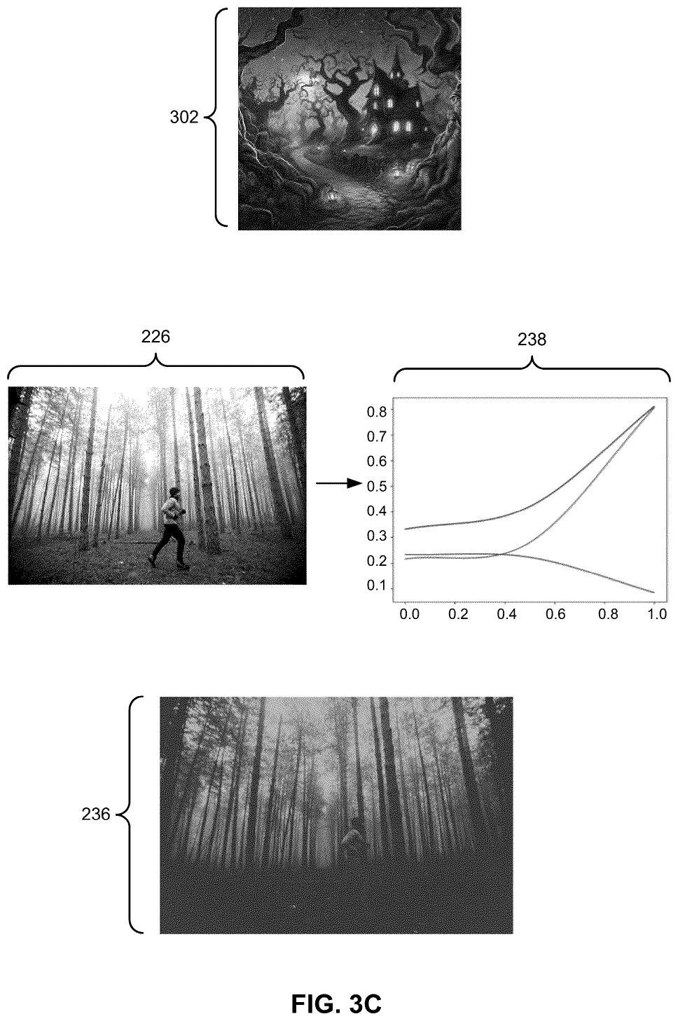

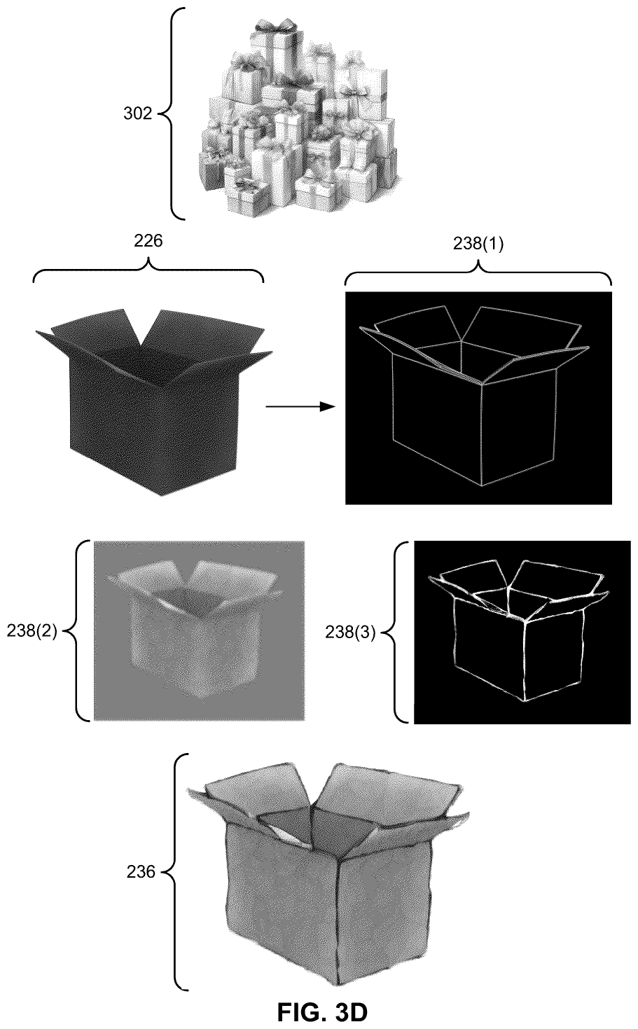

FIG. 3A shows an example style sample 302 (e.g., from style samples 218), content sample 226, and style transfer result 236, according to various embodiments. More specifically, FIG. 3A illustrates a given style transfer result 236 that is generated by optimizing pixel values of content sample 226 based on losses 234 computed between content features 228 of content sample 226 and style features 232 from a feature space associated with style sample 302. For example, style transfer result 236 could be generated by using feature extractor 202 to extract a set of content features 228 from content sample 226, using one or more encoders 204 in the trained VAE 200 to convert content features 228 into corresponding embeddings 230 in the learned latent embedding space of VAE 200, using one or more decoders 206 in the trained VAE 200 to convert embeddings 230 into a set of style features 232 in the feature space associated with style samples 218, and using an optimization technique to iteratively update pixel values of content sample 226 based on losses 234 computed between content features 228 and style features 232.

As shown in FIG. 3A, style transfer result 236 depicts the objects from content sample 226 with colors, curves, textures, and/or other style-based attributes from style sample 302. These style-based attributes can be encoded in different subsets of style features 232 from the feature space associated with style sample 302. As pixel values in content sample 226 are iteratively optimized to reduce losses 234 between content features 228 and style features 232, the objects in content sample 226 may increasingly incorporate these style-based attributes.

Returning to the discussion of FIG. 2, as discussed above, training engine 122 can train VAE 200 using multiple scales and/or variants of style samples 218. Similarly, execution engine 124 can generate style transfer result 236 by optimizing different scales and/or variants of content sample 226 using the corresponding losses 234. For example, execution engine 124 could generate style transfer result 236 by optimizing attributes 238 of multiple variants of content sample 226 over multiple corresponding optimization steps. At the beginning of each optimization step, execution engine 124 could select a different scale (e.g., using a random scale factor drawn from a log-uniform distribution and/or a gamma factor to skew toward small or large scales) and/or additional augmentations (e.g., rotations, flips, translations, etc.) to apply to content sample 226. Execution engine 124 could then perform the remainder of the optimization step by adjusting attributes 238 of the scaled and/or augmented content sample 226 using losses 234 computed between content features 228 of the scaled and/or augmented content sample 226 and the corresponding style features 232. Execution engine 124 could continue the optimization until a certain number of optimization steps has been performed, losses 234 converge and/or fall below a threshold, and/or another condition is met.

In some embodiments, execution engine 124 uses various parameterizations to customize the types and/or combinations of attributes 238 of content sample 226 to be adapted to the style-based attributes of style samples 218. These attributes 238 include (but are not limited to) pixel values, low-frequency information (e.g., sampling pixel colors with bicubic upsampling to provide a low-frequency background at full image resolution), uniform colors sampled from style samples 218, color curves representing the distribution of colors in style samples 218, alpha (e.g., transparency and/or mask) values, vector-based deformations of pixel values, regions of content sample 226, shapes, contours, types of objects, haze layers, and/or other types of differentiable data that can be composited into content sample 226. Gradients of losses 234 associated with content sample 226 and style samples 218 can thus be backpropagated to individual attributes 238 to generate style transfer result 236.

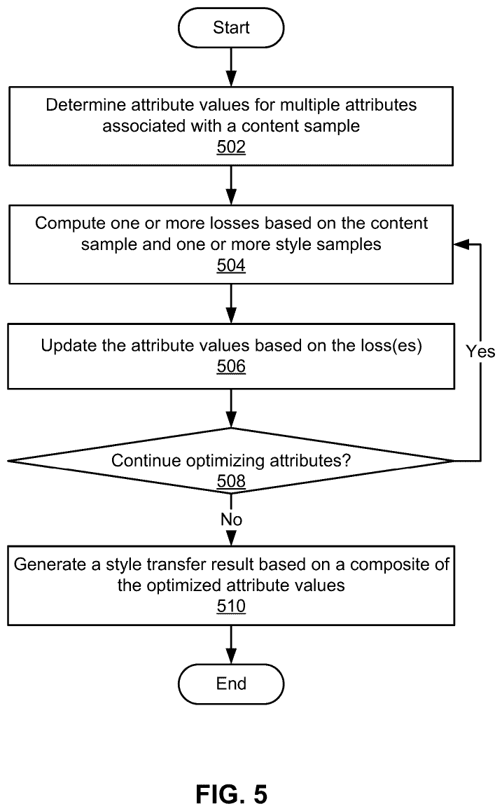

For example, execution engine 124 could determine and/or generate different “layers” of attributes 238 that can be composited into content sample 226. Each layer could include pixel-based values, parameterizations, and/or other types of attribute values for a corresponding attribute to be optimized. These layers of attributes 238 could then be optimized together or separately based on losses 234 to customize the corresponding style transfer result 236. During this optimization, constraints and/or limits (e.g., minimum values, maximum values, maximum deviations from original values, types of modification to attribute values, etc.) could be applied to the attribute values to further guide the generation of style transfer result 236. Style transfer via differential compositing of attributes 238 is described in further detail below with respect to FIGS. 3B-3D and 5.

FIG. 3B shows an example style sample 302, content sample 226, set of attributes 238(1)-238(3) associated with content sample 226, and style transfer result 236, according to various embodiments. As shown in FIG. 3B, attribute 238(1) includes a set of background colors from content sample 226, attribute 238(2) includes the interior of the objects in content sample 226, and attribute 238(3) includes the outer contours of the objects in content sample 226.

Attributes 238(1)-238(3) are optimized based on losses 234 computed between content features 228 of content sample 226 and style features 232 from a feature space associated with style sample 302 to generate a corresponding style transfer result 236. For example, style transfer result 236 could be generated by using feature extractor 202 to extract a set of content features 228 from content sample 226, using one or more encoders 204 in the trained VAE 200 to convert content features 228 into corresponding embeddings 230 in the learned latent embedding space of VAE 200, using one or more decoders 206 in the trained VAE 200 to convert embeddings 230 into a set of style features 232 in the feature space of style samples 218, and using an optimization technique to iteratively update the background colors, interior shapes of objects, and outer contours of objects in content sample 226 in a way that reduces losses 234 computed between content features 228 and style features 232. This optimization could be performed together and/or separately for each of attributes 238(1)-238(3).

As shown in FIG. 3B, style transfer result 236 incorporates background colors from style sample 302 into a pattern that is similar to the background colors depicted in content sample 226. Style transfer result 236 also includes objects with interior shapes and outer contours that are “warped” to be similar to those of style sample 302. Thus, style transfer result 236 depicts the adjustment of specific attributes 238(1)-238(3) in content sample 226 to reflect those of style sample 302.

In one or more embodiments, warping of interior shapes and outer contours of objects in content sample 226 to generate style transfer result 236 involves performing localized deformation of the interior shapes and outer contours within content sample 226 based on losses 234. More specifically, the interior shapes and outer contours corresponding to attributes 238(2) and 238(3), respectively, can be determined using corresponding displacement maps for pixels in content sample 226. Each displacement map can indicate, for a pixel associated with an interior shape and/or outer contour of an object in content sample 226, a different pixel location in content sample 226 from which the color of the pixel is to be sampled. Each displacement map can be iteratively updated based on losses 234 to transfer style-based attributes (e.g., outlines, curves, shapes, etc.) from style sample 302 to the corresponding attributes 238(2) and 238(3) of content sample 226. Because attributes 238(2) and 238(3) are updated based on existing pixel values in content sample 226, colors from the original content sample 226 are retained in the interior shapes and outer contours of objects in style transfer result 236.

Additionally, displacement maps (or other representations of warping of pixels in content sample 226 to generate style transfer result 236) can be used to enforce temporal coherency across frames of video. More specifically, vector math techniques can be used to combine motion vectors and/or other representations of optical flow from a first video frame to a second video frame with displacement maps associated with the first video frame into initial displacement maps for the second video frame. These initial displacement maps for the second video frame can then be used to perform style transfer for the second video frame. For example, the initial displacement maps could be iteratively optimized with other attributes 238 of the second video frame based on losses 234 between content features 228 associated with the second video frame and corresponding style features 232 that are matched to those content features 228. In another example, the initial displacement maps could be used to warp pixels in the second frame without further optimization based on losses 234, while one or more other attributes 238 of the second video frame that do not involve warping pixels (e.g., background colors, color curves, etc.) could be optimized based on losses 234.

FIG. 3C shows an example style sample 302, content sample 226, set of attributes 238 associated with content sample 226, and style transfer result 236, according to various embodiments. As shown in FIG. 3C, attributes 238 include a set of color curves associated with content sample 226. The y-axis associated with the color curves represents original pixel intensities from content sample 226, and the x-axis associated with the color curves represents mappings of the original pixel intensities to new pixel intensities in style transfer result 236. These color curves can be optimized based on losses 234 computed between content features 228 of content sample 226 and style features 232 from a feature space associated with style sample 302 to generate a corresponding style transfer result 236. For example, style transfer result 236 could be generated by using feature extractor 202 to extract a set of content features 228 from content sample 226, using one or more encoders 204 in the trained VAE 200 to convert content features 228 into corresponding embeddings 230 in the learned latent embedding space of VAE 200, using one or more decoders 206 in the trained VAE 200 to convert embeddings 230 into a set of style features 232 in the feature space of style samples 218, and using an optimization technique to iteratively update each of the color curves associated with content sample 226 in a way that reduces losses 234 computed between content features 228 and style features 232.

As a result of the optimization process, style transfer result 236 includes a distribution of colors that is similar to that of style sample 302. This distribution includes a greater proportion of green and blue color values and a lower proportion of red color values than content sample 226. At the same time, style transfer result 236 retains other attributes (e.g., shapes, objects, etc.) from content sample 226. Consequently, the stylization illustrated in FIG. 3C can be used to transfer the distribution of colors from style sample 302 to content sample 226 without modifying other attributes of content sample 226.

FIG. 3D shows an example style sample 302, content sample 226, set of attributes 238(1)-238(3) to be optimized in content sample 226, and style transfer result 236, according to various embodiments. As shown in FIG. 3D, style sample 302 includes an artistic depiction of a collection of boxes, and content sample 226 includes rendered content that depicts a box. Attribute 238(1) includes an alpha mask for lines detected from normals used to render content sample 226, attribute 238(2) includes a texture used to render content sample 226, and attribute 238(3) includes a set of lines associated with content sample 226.

Attributes 238(1)-238(3) are optimized based on losses 234 computed between content features 228 of content sample 226 and style features 232 from a feature space associated with style sample 302 to generate a corresponding style transfer result 236. For example, style transfer result 236 could be generated by using feature extractor 202 to extract a set of content features 228 from content sample 226, using one or more encoders 204 in the trained VAE 200 to convert content features 228 into corresponding embeddings 230 in the learned latent embedding space of VAE 200, using one or more decoders 206 in the trained VAE 200 to convert embeddings 230 into a set of style features 232 in the feature space of style samples 218, and using an optimization technique to iteratively update the alpha mask, textures, and lines in content sample 226 in a way that reduces losses 234 computed between content features 228 and style features 232. This optimization could be performed together and/or separately for each of attributes 238(1)-238(3).

As shown in FIG. 3D, style transfer result 236 includes a rendering of a box that is generated after attributes 238(1)-238(3) have been optimized based on losses 234. This rendering includes textures and displaced lines that incorporate style-based attributes of the boxes depicted in style sample 302.

Returning to the discussion of FIG. 2, in some embodiments, execution engine 124 generates style transfer result 236 to have a predefined and/or user-controlled mix or balance of content-based attributes 238 from content sample 226 and style-based attributes 238 from style samples 218. For example, execution engine 124 could perform a “partial” stylization of content sample 226 by interpolating between content sample 226 and a fully stylized style transfer result 236 that is generated by minimizing losses 234 between content features 228 and style features 232. This interpolation could be performed based on a value ranging between 0 and 1 that represents the “level of stylization” to be applied to content sample 226. As the level of stylization increases, the extent to which the corresponding style transfer result 236 incorporates attributes 238 from style samples 218 also increases. In another example, execution engine 124 could use the same interpolation techniques to apply different levels of stylization to different attributes 238 and/or regions of content sample 226. Thus, in this example, execution engine 124 could apply “full” stylization to the background of content sample 226, partial stylization to characters in the foreground of content sample 226, and/or no stylization to objects in the foreground of content sample 226.

While the operation of training engine 122 and execution engine 124 has been described above with respect to image- and/or video-based style transfer, it will be appreciated that training engine 122 and execution engine 124 can be used to perform style transfer in other types of content. For example, training engine 122 and execution engine 124 could be used to learn a feature space of features associated with style samples 218 that include audio, text, meshes, point clouds, and/or other types of data. Training engine 122 and execution engine 124 could also be used to convert a given content sample 226 that includes the same data as style samples 218 into a corresponding style transfer result 236 that incorporates style-based attributes 238 of style samples 218.

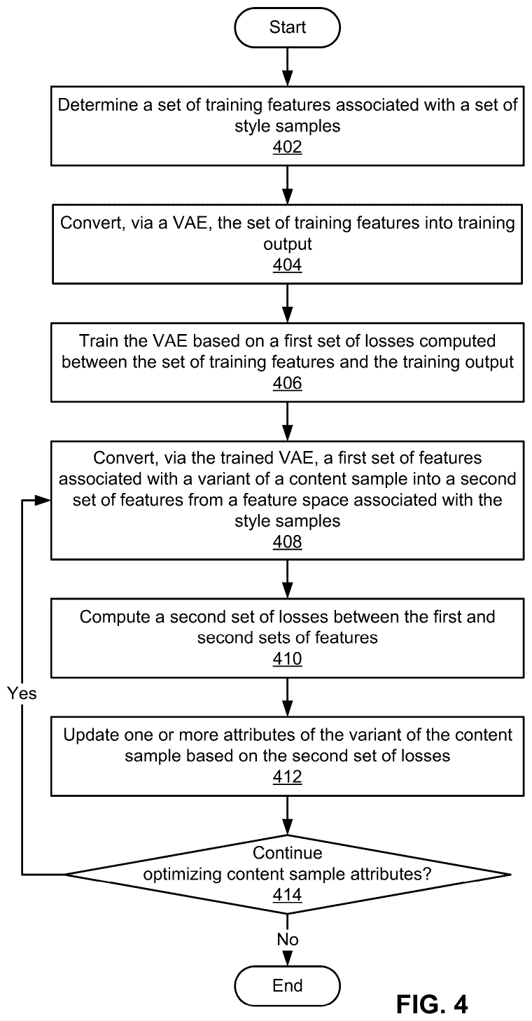

FIG. 4 is a flow diagram of method steps for performing style transfer using a variational autoencoder (VAE), according to various embodiments. Although the method steps are described in conjunction with the systems of FIGS. 1-2, persons skilled in the art will understand that any system configured to perform some or all of the method steps in any order falls within the scope of the present disclosure.

As shown, in step 402, training engine 122 determines a set of training features associated with a set of style samples. For example, training engine 122 could use a pre-trained feature extractor to convert one or more images, video frames, and/or other representations of the style samples into the set of training features. The set of training features could include multiple feature vectors that are obtained from different layers of the feature extractor. The training features could additionally be normalized by subtracting the mean of each feature channel from the corresponding feature values to generate “centered” versions of the training features.

In step 404, training engine 122 converts, via a VAE, the set of training features into training output. Continuing with the above example, the VAE could include a different encoder-decoder pair for each layer of the feature extractor used to generate the training features. Training engine 122 could input the normalized training features into a set of encoders in the VAE. Each encoder could convert a corresponding subset of the training features (e.g., a feature vector) into one or more training embeddings in a lower-dimensional latent embedding space. Training engine 122 could also input the training embeddings 208 into a set of decoders in the VAE. Each decoder could convert the inputted training embedding(s) into a subset of the training output that represents a reconstruction of the subset of training features inputted into the corresponding encoder.

In step 406, training engine 122 trains the VAE based on a first set of losses computed between the set of training features and the training output. Continuing with the above example, training engine 122 could compute a reconstruction loss between the training features and the training output and/or a KL divergence between the learned distribution of training embeddings in the lower-dimensional latent embedding space and a target distribution. Training engine 122 could then use a training technique (e.g., gradient descent and backpropagation) to iteratively update weights of the encoders and decoders of the VAE in a way that reduces subsequent losses until a certain number of training steps, iterations, batches, and/or epochs has been performed; the losses fall below a threshold; parameters of the VAE converge; and/or another condition is met.

In step 408, execution engine 124 converts, via the trained VAE, a first set of features associated with a variant of a content sample into a second set of features. Continuing with the above example, execution engine 124 could generate the variant of the content sample by scaling the content sample by a scale factor that is sampled from a distribution. Execution engine 124 could also, or instead, generate the variant by applying one or more transformations and/or augmentations to the content sample. Execution engine 124 could use the pre-trained feature extractor to generate the first set of features from the variant of the content sample. Execution engine 124 could also normalize the features and use the set of encoders in the VAE to convert different subsets of normalized features from different layers of the feature extractor into corresponding embeddings. Execution engine 124 could then use the set of decoders in the VAE to convert the embeddings into the second set of features.

In step 410, execution engine 124 computes a second set of losses between the first and second sets of features. For example, execution engine 124 could compute an L1 loss, L2 loss, perceptual loss, Euclidean distance, cosine similarity, and/or another measure of similarity, difference, and/or distance between the two sets of features.

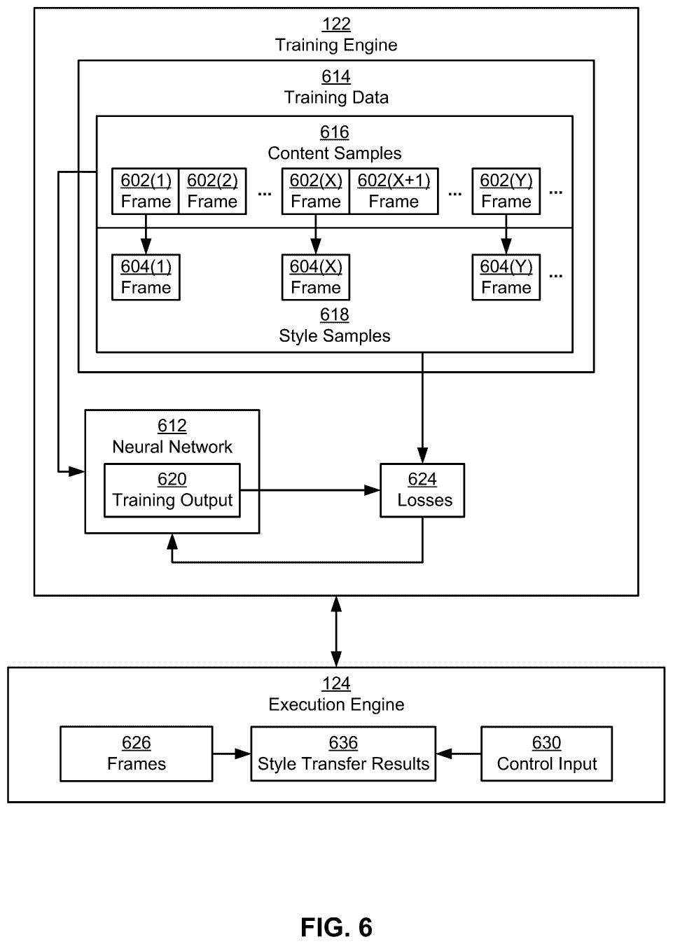

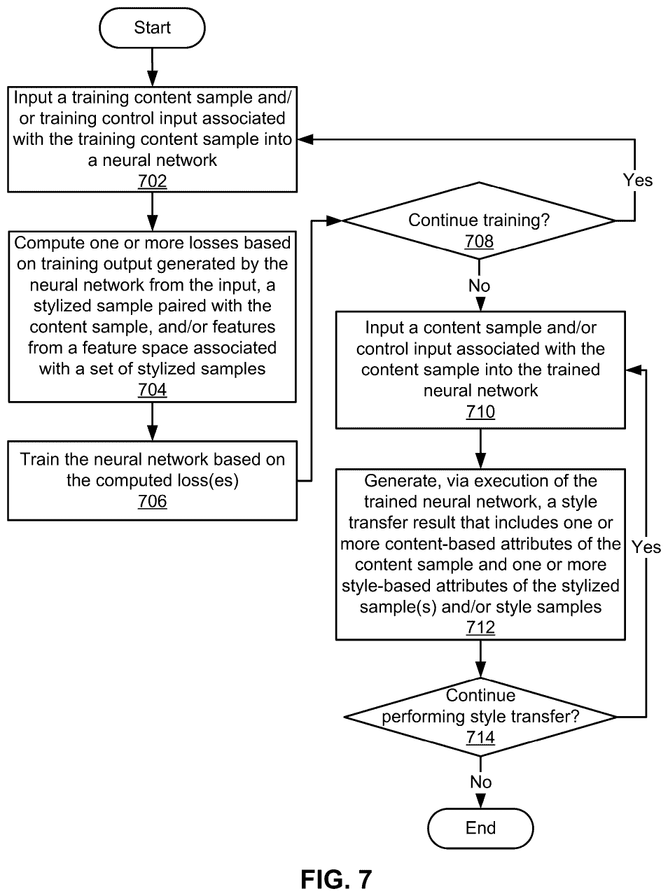

In step 412, execution engine 124 updates one or more attributes of the variant of the content sample based on the second set of losses. For example, execution engine 124 could use a coordinate descent, gradient descent, and/or another type of optimization technique to update pixel values and/or other attributes of the content sample in a way that reduces the second set of losses. Execution engine 124 could also, or instead, use a feedforward neural network that is trained using the second set of losses to convert the content sample into a style transfer result, as described in further detail below with respect to FIG. 6-7.

In step 414, execution engine 124 determines whether or not to continue optimizing content sample attributes. For example, execution engine 124 could determine that optimization of the attributes of the content sample should continue over a certain number of optimization steps, until the second set of losses falls below a threshold and/or converges, and/or until another condition is met. While execution engine 124 determines in step 414 that optimization of the attributes of the content sample is to continue, execution engine 124 repeats steps 408, 410, and 412 with a variant that is generated from the most recently updated content sample. After execution engine 124 determines in step 414 that optimization of the attributes of the content sample is to be discontinued, execution engine 124 uses one or more of the content sample variants as a style transfer result. For example, execution engine 124 could perform a final round of steps 408, 410, and 412 using a variant of the content sample at a desired scale, orientation, and/or other type of representation to generate the style transfer result. Execution engine 124 could also, or instead, generate the style transfer result using one or more variants of the content sample that were generated during one or more “intermediate” iterations of steps 408, 410, and 412. These “intermediate” variants could represent an intermediate level of stylization between the original content sample and the fully stylized version of the content sample.

FIG. 5 is a flow diagram of method steps for parametrization-based optimization of attributes during style transfer, according to various embodiments. Although the method steps are described in conjunction with the systems of FIGS. 1-2, persons skilled in the art will understand that any system configured to perform some or all of the method steps in any order falls within the scope of the present disclosure.

As shown, in step 502, execution engine 124 determines attribute values for multiple attributes associated with a content sample. For example, execution engine 124 could retrieve and/or generate different layers of attribute values and/or parameterizations of attribute values for different attributes that can be composited into the content sample. These attributes could include (but are not limited to) pixel color values, background color values, color curves, alpha channels, masks, pixel displacements, shapes, contours, outlines, lighting attributes, haze attributes, motion vectors, rendering attributes (e.g., lines, normals, textures, albedos, object identifiers, lighting attributes, etc.), and/or regions of the content sample.

In step 504, execution engine 124 computes one or more losses based on the content sample and one or more style samples. For example, execution engine 124 could use a VAE to convert content features associated with the content sample into a corresponding set of style features in a feature space associated with the style sample(s), as discussed above. Execution engine 124 could also, or instead, use a Neural Neighbor Style (NNST) technique and/or another technique to match the content features to the style features (e.g., in the absence of a VAE that can convert content features associated with the content sample into style features in a feature space associated with the style sample(s)). Execution engine 124 could then compute the loss(es) as an L1 loss, L2 loss, style loss, content loss, perceptual loss, cosine distance, Euclidean distance, and/or another type of loss based on the content features and/or style features.

In step 506, execution engine 124 updates the attribute values based on the loss(es). For example, execution engine 124 could propagate gradients associated with the loss(es) across one or more layers determined in step 502 and use the propagated gradients to update attribute values in the layer(s). During update of the attribute values, execution engine 124 could constrain the changes to the attribute values and/or parameters to limit and/or guide the modification of the corresponding attributes in the content sample.

In step 508, execution engine 124 determines whether or not to continue optimizing attributes associated with the content sample. For example, execution engine 124 could determine that optimization of attributes associated with the content sample is to continue until a certain number of optimization steps has been performed, all attributes have been updated based on the loss(es), the loss(es) converge and/or fall below a threshold, and/or another condition is met. While execution engine 124 determines that optimization of attributes associated with the content sample is to continue, execution engine 124 repeats steps 504, 506, and 508. During each iteration of steps 504, 506, and 508, execution engine 124 composites the latest attribute values into an updated content sample, determines a variant (e.g., resolution, transformation, augmentation, etc.) of the updated content sample, computes one or more losses between content features generated from the variant and style features matched to the content features, and updates the attribute values in a way that reduces the loss(es).

After execution engine 124 determines in step 508 that optimization of attributes associated with the content sample is to be discontinued, execution engine 124 performs step 510, in which execution engine 124 generates a style transfer result based on a composite of the optimized attribute values. For example, execution engine 124 could generate the style transfer result by “warping” pixels in the content sample based on a displacement map included in the optimized attribute values and/or motion vectors associated with the content sample, rendering the style transfer result based on one or more of the optimized attribute values, compositing layers of the optimized attribute values into pixel values within the style transfer result, and/or otherwise converting and/or combining the attribute values into the style transfer result. Execution engine 124 could also, or instead, control the stylization associated with different portions (e.g., regions, types of attributes, etc.) of the style transfer result by interpolating between attribute values of the content sample for a given portion of attributes and the corresponding optimized attribute values based on a level of stylization associated with that portion.

### Semi-Supervised Style Transfer

As mentioned above, training engine 122 and execution engine 124 can use a neural network (e.g., an image-to-image translation model) to perform style transfer. More specifically, training engine 122 trains the image-to-image translation model in a semi-supervised manner using (i) supervised losses computed between a set of ground truth “stylized” frames and key frames within a sequence of content video frames that correspond to the stylized frames and (ii) unsupervised style losses that are computed using a set of unannotated frames. Execution engine 124 then uses the trained neural network to generate a style transfer result by converting the unannotated frames into corresponding stylized frames that incorporate the style of the ground truth stylized frames. The operation of training engine 122 and execution engine 124 in performing semi-supervised style transfer is described in further detail below.

FIG. 6 is a more detailed illustration of training engine 122 and execution engine 124 of FIG. 1, according to various embodiments. As shown in FIG. 6, training engine 122 trains a neural network 612 using training data 614 that includes a set of content samples 616 corresponding to a set of frames 602(1), 602(2)-602(X), and 602(X+1)-602(Y) (each of which is referred to individually herein as frame 602). For example, each of content samples 616 could include a video frame 602 that depicts a shot, scene, and/or another temporally varying visual representation of one or more objects, shapes, and/or other content-based attributes. Multiple frames 602 from the same video could be used as multiple corresponding content samples 616 that depict movement, changes in perspective, and/or other changes associated with the content-based attributes.

Training data 614 also includes a set of style samples 618 corresponding to a set of frames 604(1), 604(X), and 604(Y) (each of which is referred to individually herein as frame 604). More specifically, each of style samples 618 includes a frame 604(1), 604(X), or 604(Y) that is paired with and corresponds to a stylized version of a respective frame 602(1), 602(X), or 602(Y) in content samples 616. For example, each frame 604 could include an artist-provided “paintover” of a corresponding frame 602 from a video.

In some embodiments, neural network 612 includes an image-to-image translation model, convolutional neural network, residual neural network, and/or another type of feedforward neural network that converts an input image into an output image. To train neural network 612, training engine 122 inputs frames 602 from content samples 616 that are paired with frames 604 in style samples 618 into neural network 612. Training engine 122 uses neural network 612 to convert each inputted frame 602 into training output 620 and computes an L1 loss, L2 loss, perceptual loss, and/or other supervised losses 624 between training output 620 and the corresponding frame 604 that is paired with the inputted frame 602. Training engine 122 then uses a training technique (e.g., gradient descent and backpropagation) to iteratively update weights of neural network 612 in a way that reduces these supervised losses 624.

Training engine 122 additionally inputs some or all frames 602 from content samples 616 (e.g., frames 602 that are not paired with frames 604 from style samples 618 and frames 602 that are paired with frames 604 from style samples 618) into neural network 612. Training engine 122 uses neural network 612 to convert each inputted frame 602 into training output 620 and computes one or more unsupervised losses 624 using training output 620 and/or representations of style samples 618.

For example, training engine 122 could train VAE 200 to reconstruct features generated by a pre-trained feature extractor from some or all frames 604 in style samples 618. Training engine 122 could use the pre-trained feature extractor to convert a given training output 620 generated by neural network 612 from an inputted frame 602 into a first set of features. Training engine 122 could also use the trained VAE 200 to convert the first set of features into a second set of features from a feature space associated with frames 604 in style samples 618. Training engine 122 could then compute one or more losses 624 between the two sets of features and use a training technique (e.g., gradient descent and backpropagation) to iteratively update weights of neural network 612 in a way that reduces these losses 624.

In another example, training engine 122 could use NNST and/or another technique to match content features associated with each inputted frame 602 to style features associated with frames 604 in style samples 618 (e.g., in the absence of VAE 200). Execution engine 124 could then compute an L1 loss, L2 loss, style loss, content loss, perceptual loss, cosine distance, Euclidean distance, Gram matrix, and/or other types of losses 624 based on the content features and/or style features and train neural network 612 in a way that reduces these losses 624.

It will be appreciated that training of neural network 612 using supervised and unsupervised losses 624 can be performed in a variety of ways. For example, training engine 122 could combine supervised and unsupervised losses 624 into a loss function that is used to train neural network 612 over a certain number of training batches, epochs, and/or iterations. The loss function could include a weighted sum and/or combination of the supervised and unsupervised losses 624, a regularization term that incorporates the unsupervised losses 624, and/or another combination of the supervised and unsupervised losses 624. In another example, training engine 122 could train neural network 612 over a series of training stages that alternate between supervised training using a subset of frames 602 in content samples 616 and corresponding frames 604 in style samples 618 and unsupervised training using some or all frames 602 in content samples 616 and/or features associated with some or all frames 604 in style samples 618.

In a third example, training engine 122 could perform a first set of training iterations that perform supervised training of neural network 612 using a first set of frames 602 in content samples 616 paired with a corresponding set of stylized frames 604 in style samples 618 and unsupervised training of neural network 612 using a second (larger) set of frames 602 in content samples 616. After the first set of training iterations is complete, training engine 122 could evaluate the style transfer performance of the resulting trained neural network 612 on a third set of frames 602 in content samples 616 (e.g., some or all frames 602 in content samples 616 that are not paired with stylized frames 604 in style samples 618). Training engine 122 could use the evaluated performance to select one or more additional frames 602 in the third set of frames 602 to be stylized (e.g., one or more frames 602 for which the style transfer performance of neural network 612 falls below a subjective or objective threshold). After stylized versions of the selected frames 602 are added as corresponding frames 604 to style samples 618 (e.g., after the selected frames 602 have been “painted over” or otherwise stylized by one or more artists), training engine 122 could perform a second set of training iterations that perform additional supervised training of neural network 612 using the selected frames 602 and the corresponding stylized frames 604 and additional unsupervised training of neural network 612 using additional frames 602 in content samples 616. Training engine 122 could then evaluate the style transfer performance of the trained neural network 612 after the second set of training iterations is complete. Training engine 122 could continue selecting frames 602 associated with suboptimal style transfer performance and performing additional training iterations that further train neural network 612 using the selected frames 602 and corresponding stylized frames 604 until the desired style transfer performance is achieved. In other words, training engine 122 could perform iterative training of neural network 612 using a relatively small set of targeted annotations to correct failure cases and quickly improve the style transfer performance of neural network 612.

Execution engine 124 uses the trained neural network 612 to convert one or more additional frames 626 into a set of style transfer results 636. For example, execution engine 124 could input into the trained neural network 612, as frames 626, some or all frames 602 from content samples 616 that are not paired with stylized frames 604 in style samples 618. Execution engine 124 could use layers of the trained neural network 612 to convert each inputted frame 602 into a corresponding style transfer result that includes content-based attributes of the inputted frame 602 and style-based attributes of style samples 618. Execution engine 124 could then generate a stylized video that includes an ordering of style transfer results 636 that corresponds to the ordering of frames 602 from the unstylized video.

As shown in FIG. 6, training engine 122 and execution engine 124 can incorporate control input 630 into the style transfer task performed by neural network 612. More specifically, control input 630 can be used to specify a level of stylization, type of stylization, different regions and/or types of objects associated with a given stylization, and/or other parameters associated with generating style transfer results 636 from one or more frames 626 on a per-pixel basis.

In one or more embodiments, control input 630 includes an additional channel that includes a partially stylized version of an input frame 602(e.g., a warped previous frame, a partial “paintover” and/or hand drawn image, etc.) and a control map. The control map can store weights that indicate pixel locations (or other regions or locations) at which pixel values (or other attribute values) in the stylized version should be retained and/or used to “override” a default stylization performed by neural network 612.

During training of neural network 612 using the input frame 602 and this type of control input 630, training engine 122 can use the control map to identify a subset of pixel values (or other values) in the resulting training output 620 that correspond to the additional channel. Training engine 122 can compute a first set of losses 624 based on differences between the identified subset of pixel values (or other values) and the corresponding pixel values (or other values) in the additional channel. Training engine 122 can also compute a second set of losses 624 based on differences between remaining pixel values (or other values) in training output 620 that are not associated with the additional channel and the corresponding pixel values in a “default” stylized frame 604 that is paired with an inputted frame 602 from which training output 620 was generated. This second set of losses 624 can also, or instead, be computed based on a first set of features associated with remaining pixel values (or other values) in training output 620 that are not associated with the additional channel and a second set of features from a feature space associated with style samples 618.

Training engine 122 can then train neural network 612 using the computed losses 624 so that subsequent training output 620 generated by neural network 612 from the same input frame 602, control map, and additional channel includes one or more portions that are identified in the control map as corresponding to the additional channel and match pixel values from corresponding portion(s) of the additional channel. This subsequent training output 620 can further include one or more additional portions that are identified in the control map as not corresponding to the additional channel and match corresponding pixel values in a “default” stylized frame 604 that is paired with the input frame 602. The additional portion(s) can also, or instead, include pixel values that are generated in a way that minimizes distances and/or other losses 624 between a first set of features generated from the pixel values and a second set of features from a feature space associated with style samples 618.

After training of neural network 612 using the control map and additional channel is complete, execution engine 124 can use additional control input 630 associated with a given frame inputted into the trained neural network 612 to generate a corresponding style transfer result that includes one or more regions in which the default stylization is selectively overridden by pixel values in the additional channel. For example, execution engine 124 could input, into the trained neural network 612, a frame of video to be stylized, an additional channel that stores content (e.g., a warped previous frame, partial stylization, etc.) used to override the default stylization, and a control map that includes a mask and/or other values indicating the locations at which content from the additional channel is to be used and/or the extent to which content from the additional channel is to be used. The control map could store a value ranging from 0 to 1 in each pixel location within the frame. A value of 0 would indicate that content from the additional channel is not to be used in the corresponding pixel location, while a value greater than 0 indicates that content from the additional channel is to be used in the corresponding pixel location. A value of 1 would indicate that the corresponding pixel location should fully incorporate content from the additional channel, while a positive value between 0 and 1 could be used to interpolate between content from the input frame (or content from the default stylization) and content from the additional channel.

Continuing with the above example, execution engine 124 could process the input using layers of the trained neural network 612 to generate a corresponding style transfer result. This style transfer result would include a stylized frame that includes content from the additional channel in pixel locations with nonzero values in the control map and in the proportions represented by the nonzero values. This style transfer result would also include content that represents the default stylization of the frame in pixel locations with zero values in the control map. Consequently, control input 630 can be used to generate style transfer results 636 in a way that enforces temporal coherency across frames 626 from the same video (e.g., when content from a warped adjacent frame is included in the additional channel), selectively overrides a default stylization of an input frame with additional content from the additional channel, and/or otherwise performs stylization of the frame using a default stylization and an alternative stylization.

Control input 630 also, or instead, includes a control map can be used to indicate regions of style transfer results 636 that should be synchronized with different style variants. For example, the control map could store discrete values and/or identifiers that are associated with multiple levels of stylized detail, adherence to lines and/or attributes in the inputted frame, and/or style variants of the inputted frame. Each style variant could also be provided in a corresponding channel that is inputted into neural network 612 with the control map and a given frame 602 to be stylized.

During training of neural network 612 using an input frame 602 and this type of control input 630, training engine 122 can use the control map to identify a subset of pixel values (or other values) in the resulting training output 620 that correspond to each style variant. Training engine 122 can compute a set of losses 624 based on differences between the identified subset of pixel values (or other values) and the corresponding pixel values (or other values) in the style variant. This set of losses 624 can also, or instead, be computed based on a first set of features associated with the identified subset of pixel values (or other values) and a second set of features from a feature space associated with one or more style samples 618 in the style variant.

Training engine 122 can then train neural network 612 using the computed losses 624 so that subsequent training output 620 generated by neural network 612 from the same input frame 602 and control map includes different portions that are stylized according to the corresponding style variants identified in the control map. For example, training engine 122 could train neural network 612 to produce training output 620 that includes a frame with multiple portions correspond to multiple style variants indicated in the control map. Each portion could include a different level of stylized detail (e.g., low, medium, high, etc.), type of stylization (e.g., from different artists and/or stylized frames 604), adherence to lines and/or other attributes of the original input frame 602, object from the original input frame (e.g., character, building, ground, sky, roof, road, wall, etc.), and/or another type of stylization that is represented by values stored in the control map.

After training of neural network 612 using control input 630 is complete, execution engine 124 can use additional control input 630 associated with frames 626 inputted into the trained neural network 612 to generate corresponding style transfer results 636. Each style transfer result includes a frame with multiple portions correspond to multiple style variants indicated in the control map. For example, execution engine 124 could input, into the trained neural network 612, a frame of video to be stylized and a control map that stores discrete identifiers and/or other values indicating the locations at which different style variants are to be used. The control map could also, or instead, store values that fall between two identifiers (e.g., a value between an identifier of 1 representing low stylization and an identifier of 2 representing high stylization) to interpolate between the respective style variants. Execution engine 124 could process the input using layers of the trained neural network 612 to generate a corresponding style transfer result. This style transfer result would include a stylized frame that incorporates different style variants into locations in which identifiers for the style variants are stored within the control map. This style transfer result could also, or instead, include interpolations between style variants at locations indicated in the control map as having values that fall between identifiers for the style variants. Consequently, control input 630 can be used to generate style transfer results 636 in a way that applies different style variants and/or interpolations between style variants to different portions of an input frame.

FIG. 7 is a flow diagram of method steps for performing semi-supervised style transfer, according to various embodiments. Although the method steps are described in conjunction with the systems of FIGS. 1 and 6, persons skilled in the art will understand that any system configured to perform some or all of the method steps in any order falls within the scope of the present disclosure.

As shown, in step 702, training engine 122 inputs a training content sample and/or training control input associated with the training content sample into a neural network. For example, training engine 122 could input a frame of video, a control map associated with the frame, and/or one or more style variants associated with the control map into an image-to-image translation model and/or feedforward neural network. Each style variant could include a warped version of a frame that is adjacent to the inputted frame in the video, a partial stylization of the frame, a certain level of stylization associated with the frame, a type of stylization associated with the frame, and/or another representation of stylization associated with the frame.

In step 704, training engine 122 computes one or more losses based on training output generated by the neural network from the input, a stylized sample paired with the content sample, and/or features from a feature space associated with a set of stylized samples. For example, training engine 122 could compute one or more supervised losses between the training output and the stylized sample paired with the training content sample, between one or more portions of the training input and corresponding portions of one or more style variants associated with the control map, and/or between one or more portions of the training output and another “ground truth” stylization associated with the training content sample. Training engine 122 could also, or instead, compute one or more unsupervised losses between features associated with one or more portions of the training output and features from a feature space associated with a set of stylized samples that are not paired with the training content sample (e.g., when the training content sample does not have a corresponding stylized sample).

In step 706, training engine 122 trains the neural network based on the computed loss(es). For example, training engine 122 could use a training technique (e.g., gradient descent and backpropagation) to iteratively update weights of the neural network in a way that reduces the computed loss(es).

In step 708, training engine 122 determines whether or not to continue training the neural network. For example, training engine 122 could determine that training of the neural network is to continue until a certain number of training steps, iterations, batches, and/or epochs has been performed; the loss (e) s fall below a threshold; parameters of the neural network converge; and/or another condition is met.

While training engine 122 determines that training of the neural network is to continue, training engine 122 repeats steps 702, 704, 706, and 708. For example, training engine 122 could continue training the neural network using additional training content samples, additional stylized samples paired with the additional training content samples, style variants, control maps, and/or features from a feature space associated with the stylized samples.

In another example, training engine 122 could perform iterative training of the neural network over multiple training stages, where each training stage uses a relatively small set of targeted annotations to train the neural network. During a given training stage, training engine 122 could perform a set of training iterations using steps 702, 704, and 706 to train the neural network using supervised losses associated with a small set of training content samples and a set of stylized samples paired with this set of training content samples and/or unsupervised losses associated with additional training content samples that are not paired with stylized samples. After a given training stage is complete, training engine 122 could evaluate the style transfer performance of the trained neural network using additional content samples (e.g., frames of video that are not paired with stylized samples). If training engine 122 identifies one or more content samples for which the style transfer performance of the trained neural network does not meet a threshold, training engine 122 could determine in step 708 that additional training of the neural network is to be performed using the identified content samples. Training engine 122 could also perform an additional training stage by repeating steps 702, 704, and 706 using the identified content samples and stylized samples paired with the identified content samples (e.g., artist-generated “paintovers” of the identified content samples) and/or additional content samples that are not paired with stylized samples. Training engine 122 could repeat this process until the desired style transfer performance is achieved.

Once training engine 122 determines that training of the neural network is complete, execution engine 124 performs step 710, in which execution engine 124 inputs a content sample and/or control input associated with the content sample into the trained neural network. For example, execution engine 124 could input a content sample that is not paired with a stylized sample into the trained neural network. This content sample could correspond to a frame from a video that includes additional frames used to train the neural network in steps 702, 704, and 706. Execution engine 124 could also input a control map associated with the frame and/or one or more style variants associated with the control map into the trained neural network.

In step 712, execution engine 124 generates, via execution of the trained neural network, a style transfer result that includes one or more content-based attributes of the content sample and one or more style-based attributes of the stylized sample(s) and/or style samples. Continuing with the above example, execution engine 124 could use the trained neural network to convert the frame into the style transfer result. The style transfer result could include a stylized version of the content sample that incorporates style-based attributes of stylized samples paired with other frames of the video. If input into the trained neural network also includes the control map and/or style variant(s) associated with the control map, the style transfer result could also incorporate attributes of the style variant(s) and/or interpolations associated with the style variant(s) in the locations specified in the control map.

In step 714, execution engine 124 determines whether or not to continue performing style transfer. Continuing with the above example, execution engine 124 could determine that style transfer is to continue until all frames in the video have been stylized. While execution engine 124 determines that style transfer is to continue, execution engine 124 repeats steps 710 and 712 with additional content samples (e.g., unstylized frames from the video) to generate stylized versions of the content samples. Execution engine 124 can determine that style transfer is to be discontinued after all content samples have been converted into style transfer results.

In sum, the disclosed techniques use one or more machine learning models and/or optimization techniques to perform a style transfer task, in which the style of a set of style samples (e.g., one or more images in a corresponding style) is combined with the content of a content sample (e.g., one or more images in a style that differs from that of the style sample) into a style transfer result. One or more machine learning models are trained to learn features that can be used in the style transfer task. These machine learning models include one or more variational autoencoders (VAEs) that learn to convert a set of features extracted from the style sample into one or more embeddings in a lower-dimensional latent space, and to reconstruct the set of features from the embedding(s). The machine learning models also, or instead, include an image-to-image translation model (e.g., a feedforward neural network) that is trained in a supervised manner to learn a mapping between the content associated with a sequence of video frames and a relatively small set of ground truth “stylized” frames that are paired with certain key frames within the sequence of content video frames. This image-to-image translation model can additionally be trained using unsupervised losses that are computed using features generated by the VAEs and/or other style transfer techniques.

The trained machine learning models are subsequently used to optimize for different aspects of the style transfer task. More specifically, the trained VAE can be used to project a first set of features representing a content sample into a second set of features in the feature space of the style samples. Pixel values, background colors, color curves, alpha channel values, masks, pixel displacement maps, shapes, contours, outlines, lighting attributes, haze attributes, motion vectors, rendering attributes, regions of the content sample, and/or other attributes of the content sample can then be optimized and/or adjusted until the first set of features for the content sample match the second set of features for the style sample and/or until one or more losses between the first and second set of features have been minimized. The image-to-image translation model can also, or instead, be used to apply the style associated with a set of “stylized” key frames to a sequence of content frames that include non-stylized versions of the key frames and additional video frames that lack stylized counterparts.

One technical advantage of the disclosed techniques relative to the prior art is the ability to generate high-resolution style transfer results in a computationally feasible manner. Accordingly, the disclosed techniques improve the quality of style transfer results and resource overhead over conventional approaches that involve storing features from style samples in memory. Another technical advantage of the disclosed techniques is an increase in the customizability and level of control in the style transfer process through the use of layers, parameterizations, levels of stylization, control maps, and/or style variants to adjust specific attributes of a content sample to match those of one or more style samples. An additional technical advantage of the disclosed techniques is the ability to streamline style transfer in videos via semi-supervised training of an image-to-image translation model using a limited number of paired input and output key frames from a video and style-based losses for remaining frames in the video. These technical advantages provide one or more technological improvements over prior art approaches.

1. In some embodiments, a computer-implemented method for performing style transfer comprises converting, via a trained variational autoencoder, a first set of features associated with a content sample into a second set of features from a feature space associated with one or more style samples; computing one or more losses based on the first set of features and the second set of features; and generating a style transfer result based on the content sample and the one or more losses, wherein the style transfer result comprises one or more content-based attributes of the content sample and one or more style-based attributes of the one or more style samples.

2. The computer-implemented method of clause 1, further comprising converting, via a variational autoencoder, a third set of features associated with the one or more style samples into a fourth set of features; computing one or more additional losses based on the third set of features and the fourth set of features; and generating the trained variational autoencoder by training the variational autoencoder based on the one or more additional losses.

3. The computer-implemented method of any of clauses 1-2, further comprising extracting the first set of features using a feature extractor neural network.

4. The computer-implemented method of any of clauses 1-3, wherein the first set of features is extracted from a plurality of layers included in the feature extractor neural network.

5. The computer-implemented method of any of clauses 1-4, wherein generating the style transfer result comprises iteratively updating the content sample based on the one or more losses.

6. The computer-implemented method of any of clauses 1-5, wherein converting the first set of features into the second set of features comprises converting, by an encoder neural network included in the trained variational autoencoder, the first set of features into one or more embeddings within an embedding space; and converting, by a decoder neural network included in the trained variational autoencoder, the one or more embeddings into the second set of features.

7. The computer-implemented method of any of clauses 1-6, wherein the trained variational autoencoder comprises a first encoder-decoder pair associated with a first subset of the first set of features and a second encoder-decoder pair associated with a second subset of the first set of features.

8. The computer-implemented method of any of clauses 1-7, wherein the content sample and the one or more style samples comprise at least one of an image or a sequence of video frames.

9. The computer-implemented method of any of clauses 1-8, wherein the one or more losses are computed between a first set of normalized features corresponding to the first set of features and a second set of normalized features corresponding to the second set of features.

10. The computer-implemented method of any of clauses 1-9, wherein the one or more losses comprise a distance between the first set of features and the second set of features.

11. In some embodiments, one or more non-transitory computer-readable media store instructions that, when executed by one or more processors, cause the one or more processors to perform the steps of converting, via a trained variational autoencoder, a first set of features associated with a content sample into a second set of features from a feature space associated with one or more style samples; computing one or more losses based on the first set of features and the second set of features; and generating a style transfer result based on the content sample and the one or more losses, wherein the style transfer result comprises one or more content-based attributes of the content sample and one or more style-based attributes of the one or more style samples.

12. The one or more non-transitory computer-readable media of clause 11, wherein the instructions further cause the one or more processors to perform the steps of converting, via a variational autoencoder, a third set of features associated with the one or more style samples into a fourth set of features; computing one or more additional losses between the third set of features and the fourth set of features; and generating the trained variational autoencoder by training the variational autoencoder based on the one or more additional losses.

13. The one or more non-transitory computer-readable media of any of clauses 11-12, wherein the instructions further cause the one or more processors to perform the step of extracting the first set of features using a plurality of layers included in a feature extractor neural network.

14. The one or more non-transitory computer-readable media of any of clauses 11-13, wherein the trained variational autoencoder comprises a plurality of encoder-decoder pairs corresponding to the plurality of layers.

15. The one or more non-transitory computer-readable media of any of clauses 11-14, wherein the instructions further cause the one or more processors to perform the steps of converting, via the trained variational autoencoder, a third set of features associated with a scaled version of the content sample into a fourth set of features; computing one or more additional losses between the third set of features and the fourth set of features; and generating the style transfer result based on the one or more additional losses.

16. The one or more non-transitory computer-readable media of any of clauses 11-15, wherein the instructions further cause the one or more processors to perform the step of sampling a scale associated with the scaled version of the content sample from a distribution.

17. The one or more non-transitory computer-readable media of any of clauses 11-16, wherein converting the first set of features into the second set of features comprises converting, by a set of encoder neural networks included in the trained variational autoencoder, the first set of features into one or more embeddings within an embedding space; and converting, by a set of decoder neural networks included in the trained variational autoencoder, the one or more embeddings into the second set of features.

18. The one or more non-transitory computer-readable media of any of clauses 11-17, wherein the one or more losses are computed between a first set of normalized features corresponding to the first set of features and a second set of normalized features corresponding to the second set of features.

19. The one or more non-transitory computer-readable media of any of clauses 11-18, wherein the content sample and the one or more style samples comprise at least one of an image or a sequence of video frames.

20. In some embodiments, a system comprises one or more memories that store instructions, and one or more processors that are coupled to the one or more memories and, when executing the instructions, are configured to perform the steps of converting, via a trained variational autoencoder, a first set of features associated with a content sample into a second set of features from a feature space associated with one or more style samples; computing one or more losses based on the first set of features and the second set of features; and generating a style transfer result based on the content sample and the one or more losses, wherein the style transfer result comprises one or more content-based attributes of the content sample and one or more style-based attributes of the one or more style samples.

21. In some embodiments, a computer-implemented method for performing style transfer comprises determining a first set of attribute values for a plurality of attributes associated with a content sample; computing one or more losses based on the content sample and one or more style samples; converting, based on the one or more losses, the first set of attribute values into a second set of attribute values for the plurality of attributes; and generating a style transfer result based on a composite of the second set of attribute values.

22. The computer-implemented method of clause 21, wherein determining the first set of attribute values comprises storing the first set of attribute values in a plurality of layers corresponding to the plurality of attributes.

23. The computer-implemented method of any of clauses 21-22, wherein computing the one or more losses comprises converting, via a trained variational autoencoder, a first set of features associated with the content sample into a second set of features from a feature space associated with the one or more style samples; and computing the one or more losses based on the first set of features and the second set of features.

24. The computer-implemented method of any of clauses 21-23, wherein the one or more losses comprise at least one of an L1 loss, an L2 loss, a cosine distance, a Euclidean distance, or a perceptual loss.

25. The computer-implemented method of any of clauses 21-24, wherein converting the first set of attribute values into the second set of attribute values comprises converting, based on a first loss included in the one or more losses, a first subset of the first set of attribute values into a first subset of the second set of attribute values; and converting, based on a second loss included in the one or more losses, a second subset of the first set of attribute values into a second subset of the second set of attribute values.

26. The computer-implemented method of any of clauses 21-25, wherein the first subset of the first set of attribute values corresponds to a first attribute included in the plurality of attributes and the second subset of the first set of attribute values corresponds to a second attribute included in the plurality of attributes.

27. The computer-implemented method of any of clauses 21-26, wherein converting the first set of attribute values into the second set of attribute values comprises iteratively updating the first set of attribute values based on the one or more losses.

28. The computer-implemented method of any of clauses 21-27, wherein generating the style transfer result comprises determining a set of pixel values included in the style transfer result based on an interpolation associated with the second set of attribute values.

29. The computer-implemented method of any of clauses 21-28, wherein generating the style transfer result comprises modifying a set of pixel values included in the content sample based on the second set of attribute values and a set of motion vectors associated with the content sample.

30. The computer-implemented method of any of clauses 21-29, wherein the plurality of attributes comprises at least one of a pixel color value, a background color value, a color curve, an alpha channel, a mask, a pixel displacement, a shape, a contour, an outline, a lighting attribute, a haze attribute, a motion vector, a rendering attribute, or a region of the content sample.

31. In some embodiments, one or more non-transitory computer-readable media store instructions that, when executed by one or more processors, cause the one or more processors to perform the steps of determining a first set of attribute values for a plurality of attributes associated with a content sample; computing one or more losses based on the content sample and one or more style samples; converting, based on the one or more losses, the first set of attribute values into a second set of attribute values for the plurality of attributes; and generating a style transfer result based on a composite of the second set of attribute values.

32. The one or more non-transitory computer-readable media of clause 31, wherein determining the first set of attribute values comprises generating a set of parameters representing an attribute included in the plurality of attributes.

33. The one or more non-transitory computer-readable media of any of clauses 31-32, wherein converting the first set of attribute values into the second set of attribute values comprises iteratively updating the set of parameters based on the one or more losses and a set of constraints associated with the set of parameters.

34. The one or more non-transitory computer-readable media of any of clauses 31-33, wherein computing the one or more losses comprises generating, via one or more neural networks, a first set of features associated with the content sample and a second set of features associated with the one or more style samples; and computing the one or more losses based on the first set of features and the second set of features.

35. The one or more non-transitory computer-readable media of any of clauses 31-34, wherein computing the one or more losses further comprises matching the first set of features to the second set of features based on one or more distances computed between the first set of features and the second set of features.

36. The one or more non-transitory computer-readable media of any of clauses 31-35, wherein generating the style transfer result comprises determining a first level of stylization associated with a first attribute included in the plurality of attributes and a second level of stylization associated with a second attribute included in the plurality of attributes; determining a first interpolation associated with a first subset of the second set of attribute values based on the first level of stylization and a second interpolation associated with a second subset of the second set of attribute values based on the second level of stylization; and determining a set of pixel values included in the style transfer result based on the first interpolation and the second interpolation.

37. The one or more non-transitory computer-readable media of any of clauses 31-36, wherein generating the style transfer result comprises displacing a set of pixel values included in the content sample based on a displacement map included in the second set of attribute values.

38. The one or more non-transitory computer-readable media of any of clauses 31-37, wherein the plurality of attributes comprises at least one of a pixel color value, a background color value, a color curve, an alpha channel, a mask, a pixel displacement, a shape, a contour, an outline, a lighting attribute, a haze attribute, a motion vector, a rendering attribute, or a region of the content sample.

39. The one or more non-transitory computer-readable media of any of clauses 31-38, wherein the one or more losses comprise at least one of a style loss, a content loss, a perceptual loss, an L1 loss, or an L2 loss.

40. In some embodiments, a system comprises one or more memories that store instructions, and one or more processors that are coupled to the one or more memories and, when executing the instructions, are configured to perform the steps of determining a first set of attribute values for a plurality of attributes associated with a content sample; computing one or more losses based on the content sample and one or more style samples; converting, based on the one or more losses, the first set of attribute values into a second set of attribute values for the plurality of attributes; and generating a style transfer result based on a composite of the second set of attribute values.

41. In some embodiments, a computer-implemented method for performing style transfer comprises training a neural network based on (i) one or more supervised losses computed between a first set of training output produced by the neural network from a first set of training content samples and a set of stylized samples corresponding to the first set of training content samples, and (ii) one or more unsupervised losses computed using a second set of training output produced by the neural network from a second set of training content samples to generate a trained neural network; inputting a content sample into the trained neural network; and generating, via execution of the trained neural network, a style transfer result that comprises one or more content-based attributes of the content sample and one or more style-based attributes of the set of stylized samples.

42. The computer-implemented method of clause 41, wherein training the neural network comprises converting, via a trained variational autoencoder, a first set of features associated with the second set of training output into a second set of features from a feature space associated with the set of stylized samples; and computing the one or more unsupervised losses based on the first set of features and the second set of features.

43. The computer-implemented method of any of clauses 41-42, wherein training the neural network further comprises extracting the first set of features from a plurality of layers included in a feature extractor neural network.

44. The computer-implemented method of any of clauses 41-43, wherein training the neural network comprises generating a first version of the trained neural network via a first set of training iterations that train the neural network using a first subset of the first set of training content samples and a first subset of the set of stylized samples corresponding to the first subset of the first set of training content samples; determining a second subset of the first set of training content samples based on a style transfer performance associated with the first version of the trained neural network; and generating a second version of the trained neural network via a second set of training iterations that further train the first version of the trained neural network using the second subset of the first set of training content samples and a second subset of the set of stylized samples corresponding to the second subset of the first set of training content samples.

45. The computer-implemented method of any of clauses 41-44, wherein generating the style transfer result comprises determining a control map associated with the content sample, wherein the control map comprises a plurality of values for a plurality of locations in the content sample; and combining, via execution of the trained neural network, the control map and the content sample into the style transfer result, wherein the style transfer result comprises a plurality of style variants corresponding to the plurality of values in the plurality of locations.

46. The computer-implemented method of any of clauses 41-45, wherein the plurality of style variants comprises a first style variant corresponding to the set of stylized samples and a second style variant corresponding to an additional stylized sample associated with the control map.

47. The computer-implemented method of any of clauses 41-46, wherein the additional stylized sample comprises at least one of a partial stylization of the content sample, a warped stylization of an additional content sample that is temporally related to the content sample, or a level of stylization that is different from the set of stylized samples.

48. The computer-implemented method of any of clauses 41-47, wherein the first set of training content samples and the second set of training content samples each comprise a sequence of video frames.

49. The computer-implemented method of any of clauses 41-48, wherein the set of stylized samples comprise stylizations of one or more key frames that are included in the sequence of video frames and correspond to the first set of training content samples.

50. The computer-implemented method of any of clauses 41-49, wherein the one or more unsupervised losses comprise at least one of a style loss, a content loss, a perceptual loss, a cosine distance, or a Euclidean distance.

51. In some embodiments, one or more non-transitory computer-readable media store instructions that, when executed by one or more processors, cause the one or more processors to perform the steps of training a neural network based on (i) one or more supervised losses computed between a first set of training output produced by the neural network from a first set of training content samples and a set of stylized samples corresponding to the first set of training content samples, and (ii) one or more unsupervised losses computed using a second set of training output produced by the neural network from a second set of training content samples to generate a trained neural network; inputting a content sample into the trained neural network; and generating, via execution of the trained neural network, a style transfer result that comprises one or more content-based attributes of the content sample and one or more style-based attributes of the set of stylized samples.

52. The one or more non-transitory computer-readable media of clause 51, wherein training the neural network comprises converting, via a feature extractor neural network, the second set of training output into a first set of features; converting, via a trained variational autoencoder, the first set of features into a second set of features from a feature space associated with the set of stylized samples; and computing the one or more unsupervised losses based on the first set of features and the second set of features.

53. The one or more non-transitory computer-readable media of any of clauses 51-52, wherein training the neural network comprises generating a first version of the trained neural network via a first set of training iterations that train the neural network using a first subset of the first set of training content samples and a first subset of the set of stylized samples corresponding to the first subset of the first set of training content samples; determining a second subset of the first set of training content samples based on a third set of training output generated by the first version of the trained neural network from a third set of training content samples; and generating a second version of the trained neural network via a second set of training iterations that further train the first version of the trained neural network using the second subset of the first set of training content samples and a second subset of the set of stylized samples corresponding to the second subset of the first set of training content samples.

54. The one or more non-transitory computer-readable media of any of clauses 51-53, wherein training the neural network comprises inputting a training content sample included in the first set of training content samples and a control map into the neural network, wherein the control map comprises a plurality of values corresponding to a plurality of locations in the content sample; and computing the one or more supervised losses based on (i) training output that is included in the first set of training output and generated by the neural network from the inputted training content sample and the inputted control map and (ii) one or more additional stylized samples corresponding to the training content sample and the control map.

55. The one or more non-transitory computer-readable media of any of clauses 51-54, wherein the one or more additional stylized samples comprise at least one of a warped version of a stylized sample included in the set of stylized samples, a partial stylization of the training content sample, or a style variant associated with the training content sample.

56. The one or more non-transitory computer-readable media of any of clauses 51-55, wherein the plurality of values comprises a first identifier for a first stylized sample included in the one or more additional stylized samples and a second identifier for a second stylized sample included in the one or more additional stylized samples.

57. The one or more non-transitory computer-readable media of any of clauses 51-56, wherein the plurality of values comprise a mask associated with the one or more additional stylized samples.

58. The one or more non-transitory computer-readable media of any of clauses 51-57, wherein the neural network is trained using a weighted combination of the one or more supervised losses and the one or more unsupervised losses.

59. The one or more non-transitory computer-readable media of any of clauses 51-58, wherein the trained neural network comprises a feedforward image-to-image translation model.

60. In some embodiments, a system comprises one or more memories that store instructions, and one or more processors that are coupled to the one or more memories and, when executing the instructions, are configured to perform the steps of determining a plurality of parameters corresponding to a trained neural network, wherein the trained neural network is generated by training a neural network based on (i) one or more supervised losses computed between a first set of training output produced by the neural network from a first set of training content samples and a set of stylized samples corresponding to the first set of training content samples and (ii) one or more unsupervised losses computed using a second set of training output produced by the neural network from a second set of training content samples; inputting a content sample into the trained neural network; and generating, via execution of the trained neural network, a style transfer result that comprises one or more content-based attributes of the content sample and one or more style-based attributes of the set of stylized samples.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing style transfer, the method comprising:
determining a first set of attribute values for a plurality of attributes associated with a content sample;
computing one or more losses based on the content sample and one or more style samples;
converting, based on the one or more losses, the first set of attribute values into a second set of attribute values for the plurality of attributes; and
generating a style transfer result based on a composite of the second set of attribute values.

2. The computer-implemented method of claim 1, wherein determining the first set of attribute values comprises storing the first set of attribute values in a plurality of layers corresponding to the plurality of attributes.

3. The computer-implemented method of claim 1, wherein computing the one or more losses comprises:
converting, via a trained variational autoencoder, a first set of features associated with the content sample into a second set of features from a feature space associated with the one or more style samples; and
computing the one or more losses based on the first set of features and the second set of features.

4. The computer-implemented method of claim 3, wherein the one or more losses comprise at least one of an L1 loss, an L2 loss, a cosine distance, a Euclidean distance, or a perceptual loss.

5. The computer-implemented method of claim 1, wherein converting the first set of attribute values into the second set of attribute values comprises:
converting, based on a first loss included in the one or more losses, a first subset of the first set of attribute values into a first subset of the second set of attribute values; and
converting, based on a second loss included in the one or more losses, a second subset of the first set of attribute values into a second subset of the second set of attribute values.

6. The computer-implemented method of claim 5, wherein the first subset of the first set of attribute values corresponds to a first attribute included in the plurality of attributes and the second subset of the first set of attribute values corresponds to a second attribute included in the plurality of attributes.

7. The computer-implemented method of claim 1, wherein converting the first set of attribute values into the second set of attribute values comprises iteratively updating the first set of attribute values based on the one or more losses.

8. The computer-implemented method of claim 1, wherein generating the style transfer result comprises determining a set of pixel values included in the style transfer result based on an interpolation associated with the second set of attribute values.

9. The computer-implemented method of claim 1, wherein generating the style transfer result comprises modifying a set of pixel values included in the content sample based on the second set of attribute values and a set of motion vectors associated with the content sample.

10. The computer-implemented method of claim 1, wherein the plurality of attributes comprises at least one of a pixel color value, a background color value, a color curve, an alpha channel, a mask, a pixel displacement, a shape, a contour, an outline, a lighting attribute, a haze attribute, a motion vector, a rendering attribute, or a region of the content sample.

11. One or more non-transitory computer-readable media storing instructions that, when executed by one or more processors, cause the one or more processors to perform the steps of:
determining a first set of attribute values for a plurality of attributes associated with a content sample;
computing one or more losses based on the content sample and one or more style samples;
converting, based on the one or more losses, the first set of attribute values into a second set of attribute values for the plurality of attributes; and
generating a style transfer result based on a composite of the second set of attribute values.

12. The one or more non-transitory computer-readable media of claim 11, wherein determining the first set of attribute values comprises generating a set of parameters representing an attribute included in the plurality of attributes.

13. The one or more non-transitory computer-readable media of claim 12, wherein converting the first set of attribute values into the second set of attribute values comprises iteratively updating the set of parameters based on the one or more losses and a set of constraints associated with the set of parameters.

14. The one or more non-transitory computer-readable media of claim 11, wherein computing the one or more losses comprises:
generating, via one or more neural networks, a first set of features associated with the content sample and a second set of features associated with the one or more style samples; and
computing the one or more losses based on the first set of features and the second set of features.

15. The one or more non-transitory computer-readable media of claim 14, wherein computing the one or more losses further comprises matching the first set of features to the second set of features based on one or more distances computed between the first set of features and the second set of features.

16. The one or more non-transitory computer-readable media of claim 11, wherein generating the style transfer result comprises:
determining a first level of stylization associated with a first attribute included in the plurality of attributes and a second level of stylization associated with a second attribute included in the plurality of attributes;
determining a first interpolation associated with a first subset of the second set of attribute values based on the first level of stylization and a second interpolation associated with a second subset of the second set of attribute values based on the second level of stylization; and
determining a set of pixel values included in the style transfer result based on the first interpolation and the second interpolation.

17. The one or more non-transitory computer-readable media of claim 11, wherein generating the style transfer result comprises displacing a set of pixel values included in the content sample based on a displacement map included in the second set of attribute values.

18. The one or more non-transitory computer-readable media of claim 11, wherein the plurality of attributes comprises at least one of a pixel color value, a background color value, a color curve, an alpha channel, a mask, a pixel displacement, a shape, a contour, an outline, a lighting attribute, a haze attribute, a motion vector, a rendering attribute, or a region of the content sample.

19. The one or more non-transitory computer-readable media of claim 11, wherein the one or more losses comprise at least one of a style loss, a content loss, a perceptual loss, an L1 loss, or an L2 loss.

20. A system, comprising:
one or more memories that store instructions, and
one or more processors that are coupled to the one or more memories and, when executing the instructions, are configured to perform the steps of:
determining a first set of attribute values for a plurality of attributes associated with a content sample;
computing one or more losses based on the content sample and one or more style samples;
converting, based on the one or more losses, the first set of attribute values into a second set of attribute values for the plurality of attributes; and
generating a style transfer result based on a composite of the second set of attribute values.
